(19) United States
(12) Patent Application Publication
(10) Pub. No.: US 2026/0105495 A1
(43) Pub. Date: Apr. 16, 2026

(54) MARKETING CAMPAIGN CUSTOMIZATION

(71) Applicant: Walmart Apollo, LLC, Bentonville, AR (US)

(72) Inventors: Amlan Jyoti Das, Bangalore (IN); Srikant Sahoo, Bhubaneshwar (IN); Abin Abraham, Bangalore (IN); Satya Narayan, Bangalore (IN)

(21) Appl. No.: 19/325,331

(22) Filed: Sep. 10, 2025

Related U.S. Application Data
(60) Provisional application No. 63/707,586, filed on Oct. 15, 2024.
(60) Provisional application No. 63/707,583, filed on Oct. 15, 2024.

(51) Int. Cl. G06Q 30/0241

(52) U.S. Cl. CPC G06Q 30/0276

(57) ABSTRACT

Systems and methods for automatically generating and updating a customized marketing campaign are disclosed. An example may involve: receiving a query in natural language form associated with a marketing campaign; generating, based on the query, a list of filters each associated with a corresponding customer attribute; determining a list of target customers based on the list of filters and at least one user input regarding the list of filters; and transmitting the list of target customers to a computing device for creating or updating the marketing campaign.

### CROSS-REFERENCE TO RELATED APPLICATIONS

This application claims priority to U.S. Provisional Application No. 63/707,586 filed on Oct. 15, 2024 and entitled “Marketing Campaign Customization,” and to U.S. Provisional Application No. 63/707,583 filed on Oct. 15, 2024 and entitled “Recommendations Based on Customer Persona,” the disclosures of each of which are incorporated herein by reference in each of their entireties.

### TECHNICAL FIELD

This disclosure relates to systems and methods for generating and updating a customized marketing campaign.

### BACKGROUND

A retailer may have a diverse customer base, which poses challenges in maintaining consistent shopping experiences and analyzing customer behavior for targeted marketing. When a marketplace seller wants to sell a product, especially a new product that has never been sold before, it is important to determine a selected market (e.g. stores and fulfillment centers) for the product to be sold or listed for delivering. Without correctly understanding the market and customer base around a store, existing systems may be unable to provide optimal market recommendation or insights to sellers. A lack of actionable insights often leads the sellers and suppliers to focus on less profitable markets, wasting resources and affecting competitive pricing.

In addition, a seller may create a marketing campaign to promote one or more products on sale. During a planning phase of the marketing campaign, the seller wants to find target customers for improving performance of the marketing campaign. Existing solutions may fail to create customer segments from latent information for marketing campaigns.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for generating and updating a customized marketing campaign, in accordance with some embodiments;

FIG. 2 is a block diagram of a persona based recommendation device, in accordance with some embodiments;

FIG. 3 is a block diagram illustrating various portions of a system for generating and updating a customized marketing campaign, in accordance with some embodiments;

FIG. 4 illustrates an example process for performing persona based recommendation, in accordance with some embodiments;

FIG. 5 illustrates an example architecture of a system for performing persona based recommendation, in accordance with some embodiments;

FIG. 6 illustrates an example process for customizing a marketing campaign, in accordance with some embodiments;

FIG. 7 illustrates an example process for recommending market locations, in accordance with some embodiments;

FIG. 8 illustrates an example process for persona basket identification, in accordance with some embodiments;

FIG. 9 illustrates an example process for persona customer identification, in accordance with some embodiments;

FIG. 10 illustrates an example process for computing persona concentration in pixels, in accordance with some embodiments;

FIG. 11 illustrates an example process for generating a customer segment for a marketing campaign, in accordance with some embodiments;

FIG. 12 illustrates an example process for modifying a customer segment for a marketing campaign, in accordance with some embodiments;

FIG. 13 illustrates an example front-end frame for generating a customer segment for a marketing campaign, in accordance with some embodiments;

FIG. 14 shows a flowchart illustrating an example method for generating a customer segment for a marketing campaign, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Understanding a geo-demand (e.g. the number of customers who are in demand of a given product in a configured geographical location) based on various personas of customers is very important to serve the customers according to their need and motivate them to keep coming back. For a seller, it is important to find a right market for its products on sale, and to find target customers for its marketing campaign promoting its products.

One objective of various embodiments in the present teaching is to develop a system that enables capturing geo-demand of products based on a specific customer type (e.g., persona and deterministic features) on the fly with minimal wait time, and determining target customer segments in real-time for marketing campaigns by fusing latent information with deterministic customer features.

In some embodiments, the system provides an end-to-end automated flow that can take customer persona description (and additionally other customer features like demographics, brand preference, spent, etc.) as user request on demand to generate the optimal markets present according to historical data. The market size is configurable according to the pixel size or an ideal sized region can be formed by a combination of smallest pixel sizes. A pixel is a unit of the market size, and the most granular geographical region within the market. Multiple pixels can be combined together to create a market of a given geographical region.

The system can also provide an interactive geo-spatial user-interface (UI) attached to use-case specific solutions to enable a business to be more pro-active in decision making. The system thus builds a generic and scalable solution that enables faster recommendation generation and actionability.

In some embodiments, the system can generate a customer persona-specific configurable geo-demand view along with data driven intelligent recommendations, which can be utilized to solve problems across business domains. This provides a unique solution to understand the geo-demand for suitable use cases (hyper-localized assortment, markets for new product introduction, optimal inventory allocation etc.) that combines generative artificial intelligence (AI) and geo-visualization capabilities together in an actionable tool for business to take faster decisions. The system provides a UI that is interactive not only at visualization level but also captures the versatility associated with customers via a query mechanism without any manual intervention.

In some embodiments, the system provides recommendations based on a process including the following primary steps. First, the system identifies products associated with a query using recurring calls to a large language model (LLM). Second, the system performs real time customer identification of a customer base associated with the query using LLM and pre-created customer embeddings (e.g. embeddings created from all customer data available in a retailer ecosystem). Third, the system maps identified customers using pixels, e.g. facilitated by geo-spatial indexes. Last but not least, the system can create recommendations for different use cases. For example, the system can identify an assortment gap for a store and recommend to diminish that gap with an accurate evaluation of the gap size based on persona computation.

In some embodiments, the system can leverage customer personas and pixels to optimize market profiling. A retailer business relies on a vast network of sellers and suppliers. An accurate market insights are crucial for sellers and suppliers to set competitive prices and allocate resources effectively. When a seller wants to introduce a product for sale (e.g. a cold-start product that has no or little sale history), the system can determine and recommend an ideal market (e.g. stores and fulfillment centers for the product to be sold or listed for delivering) and/or geo-demand of the market for selling the product. In some embodiments, the system can add more dimensions to customer data to improve depth and accuracy of the recommendations.

In some embodiments, the system can leverage customer personas and pixels to generate customer segments for marketing campaigns. When a seller wants to create a marketing campaign to promote a product for sale, the system can determine and recommend an ideal customer list to be targeted by the marketing campaign. In some embodiments, the system can create this customer list on the fly by an interaction or conversation with the seller via a chatbot, based on some natural language model, e.g. a large language model.

In some embodiments, the system can utilize a geo-spatial data processing and visualization platform built for large-scale geospatial analytics, providing valuable insights for business growth and development. The platform efficiently aggregates and processes data from various sources, such as customer data, transactions, and trip details, and stores the processed information in a specialized database for all geo-tagged data. The term “persona” may refer to the aspect of customers' characteristics perceived from the transactions done by the customers. Unlike demographics, geographic or behavioral, persona aims to track much finer traits associated with customers, by focusing on customer personalities, interests, hobbies, values, lifestyles, life goals, priorities, shopping psychographics, etc.

In some embodiments, one or more filtering and/or review processes may be implemented at various stages to identify and/or prevent generation of undesirable content by the large language model or any other model utilized by the disclosed system. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

In various embodiments, a system including a processor and a non-transitory memory storing instructions is disclosed. The instructions, when executed, cause the processor to: receive a query in natural language form associated with a marketing campaign; generate, based on the query, a list of filters each associated with a corresponding customer attribute; determine a list of target customers based on the list of filters and at least one user input regarding the list of filters; and transmit the list of target customers to a computing device for creating or updating the marketing campaign.

In various embodiments, a computer-implemented method is disclosed. The computer-implemented method includes: receiving a query in natural language form associated with a marketing campaign; generating, based on the query, a list of filters each associated with a corresponding customer attribute; determining a list of target customers based on the list of filters and at least one user input regarding the list of filters; and transmitting the list of target customers to a computing device for creating or updating the marketing campaign.

In various embodiments, a non-transitory computer readable medium having instructions stored thereon is disclosed. The instructions, when executed by at least one processor, cause at least one device to perform operations including: receiving a query in natural language form associated with a marketing campaign; generating, based on the query, a list of filters each associated with a corresponding customer attribute; determining a list of target customers based on the list of filters and at least one user input regarding the list of filters; and transmitting the list of target customers to a computing device for creating or updating the marketing campaign.

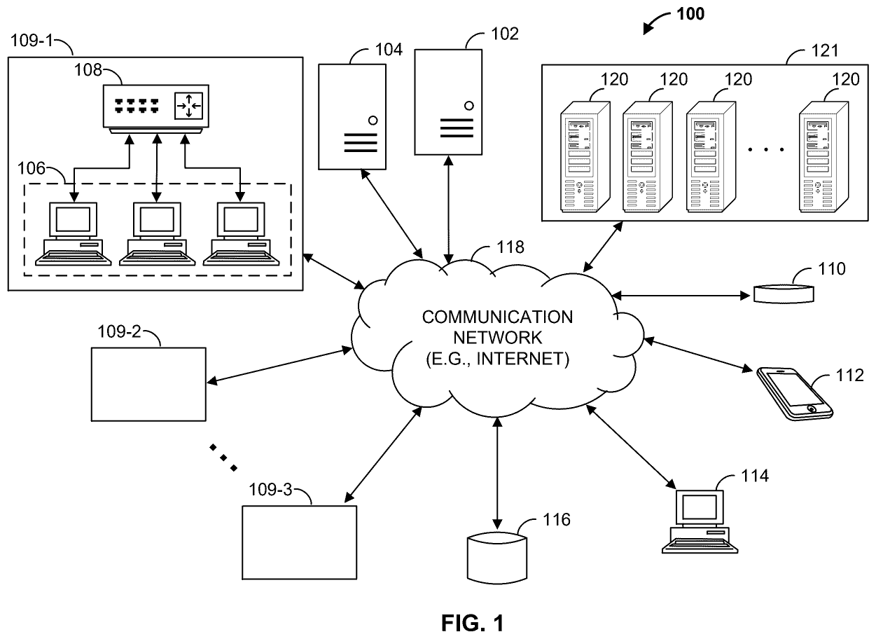

Turning to the drawings, FIG. 1 is a network environment 100 configured for generating and updating a customized marketing campaign, in accordance with some embodiments. The network environment 100 includes a plurality of devices or systems that can communicate over one or more network channels, illustrated as a network cloud 118. For example, in various embodiments, the network environment 100 can include, but not limited to, a persona based recommendation device 102, a server 104 (e.g., a web server or an application server), a cloud-based engine 121 including one or more processing devices 120, workstation(s) 106, a database 116, and one or more user computing devices 110, 112, 114 operatively coupled over the network 118. The persona based recommendation device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the persona based recommendation device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the persona based recommendation device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the persona based recommendation device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 can communicate with the persona based recommendation device 102 over the communication network 118. The workstation(s) 106 may send data to, and receive data from, the persona based recommendation device 102. For example, the workstation(s) 106 may transmit data identifying transactions, inventory, assortment, supply chain data and/or waste data at the one or more fulfillment nodes 109 to the persona based recommendation device 102. The workstation(s) 106 may also transmit other data related to the one or more fulfillment nodes 109 to the persona based recommendation device 102.

Although FIG. 1 illustrates three user computing devices 110, 112, 114, the network environment 100 can include any number of user computing devices 110, 112, 114. Similarly, the network environment 100 can include any number of the persona based recommendation devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the persona based recommendation device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the persona based recommendation device 102.

In some embodiments, a seller or supplier on a retail platform hosted by the server 104 may operate one of the user computing devices 110, 112, 114 to access an application programming interface (API) or the retail platform website hosted by the server 104. The seller may, via the API or website, submit a product for sale on the retail platform, and view recommendation data indicating one or more market locations that are best to sell this product and insight data on geo-demands related to the product and the market locations. The seller may provide feedback data to the persona based recommendation device 102, to indicate an effectiveness of these recommendations after selling the product at the recommended markets for a time period. The API or website may capture these activities of the seller as user session data or as they are, and transmit these activities to the persona based recommendation device 102 over the communication network 118.

In some embodiments, a seller or advertiser may operate one of the user computing devices 110, 112, 114 to have a conversation with a chatbot hosted by the server 104. The seller may, via the chatbot, submit a query to create a marketing campaign to promote one or more products, and ask the chatbot to recommend target customers to be targeted by the marketing campaign. The server 104 may send a recommendation request to the persona based recommendation device 102, which can generate recommendation data indicating target customers for the marketing campaign to better and efficiently promote the one or more products, e.g. based on a given market location. The seller can view the recommendation data and provide feedback data to the persona based recommendation device 102, to indicate an effectiveness of these recommendations after running the marketing campaign for a time period. The chatbot may capture these activities of the seller as user session data or as they are, and transmit these activities to the persona based recommendation device 102 over the communication network 118.

In some examples, the persona based recommendation device 102 may receive a recommendation request from the server 104. The recommendation request may be sent standalone or together with data associated with a retail fulfillment network (or called supply chain network or distribution network) of the retailer, to seek recommendations on target customers for a marketing campaign or best-suited marketplace for selling products in the retail fulfillment network. In response, the persona based recommendation device 102 generates recommendation data indicating recommendations regarding market locations and target customers, and transmits the recommendation data to the server 104. The persona based recommendation device 102 may receive feedback data from the users (associates or sellers) regarding effectiveness of the recommendations, and generate and provide updated recommendation data to the users based on the feedback.

In some embodiments, the persona based recommendation device 102 is further operable to communicate with the database 116 over the communication network 118. For example, the persona based recommendation device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the persona based recommendation device 102, in some examples, the database 116 can be a local storage device, such as a hard drive, a non-volatile memory, or a USB stick. For example, the persona based recommendation device 102 may store online purchase data received from the server 104 in the database 116. The persona based recommendation device 102 may receive in-store purchase data and node related data from different fulfillment nodes 109 and store them in the database 116. The persona based recommendation device 102 may also receive from the server 104 user session data identifying events associated with browsing sessions, and may store the user session data in the database 116. The persona based recommendation device 102 may also compute recommendation data in response to a recommendation request received from the server 104 (or the fulfillment nodes 109), and may store the recommendation data in the database 116.

In some examples, the persona based recommendation device 102 generates and/or updates different models (e.g., machine learning models, deep learning models, statistical models, algorithms, etc.) for generating and updating a customized marketing campaign. The persona based recommendation device 102 may generate training data for the models based on data including but not limited to: item features, store features, customer attribute data, historical persona data, historical campaign data, historical recommendation data, and historical feedback data. The persona based recommendation device 102 trains the models based on their corresponding training data, and stores the models in a database, such as in the database 116 (e.g., a cloud storage). The models, when executed by the persona based recommendation device 102, allow the persona based recommendation device 102 to generate insights and recommendations for a customized marketing campaign.

In some examples, the persona based recommendation device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the persona based recommendation device 102 may generate insights and recommendations for a customized marketing campaign.

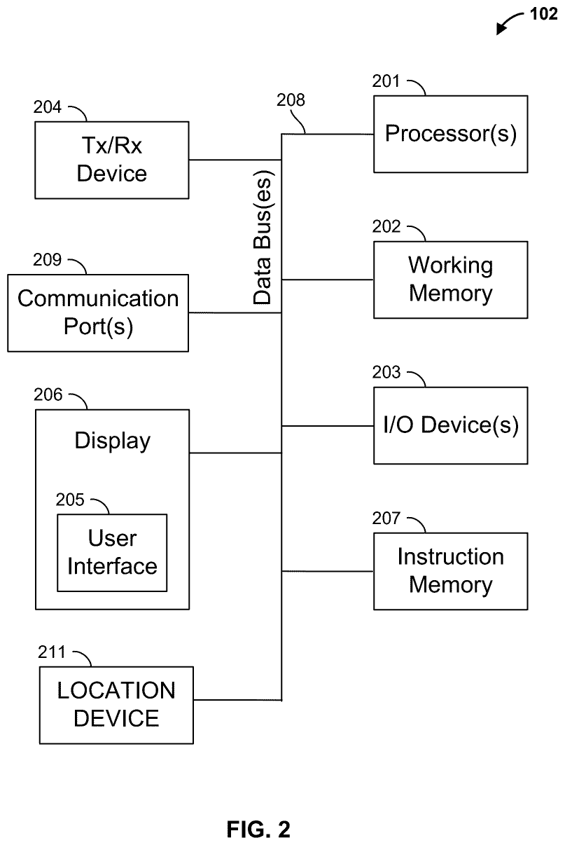

FIG. 2 illustrates a block diagram of a persona based recommendation device, e.g. the persona based recommendation device 102 of FIG. 1, in accordance with some embodiments. In some embodiments, each of the persona based recommendation device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the persona based recommendation device 102 can be combined, omitted, and/or replicated. In addition, it will be appreciated that additional elements other than those illustrated in FIG. 2 can be added to the persona based recommendation device 102.

As shown in FIG. 2, the persona based recommendation device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the persona based recommendation device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the persona based recommendation device 102 can include a single memory unit to operate as both instruction memory and working memory. Further, although embodiments are discussed herein including non-volatile memory, it will be appreciated that the persona based recommendation device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 allows communications with the cellular network. In some embodiments, the transceiver 204 is selected based on the type of the communication network 118 the persona based recommendation device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the persona based recommendation device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 may couple the persona based recommendation device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the persona based recommendation device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the persona based recommendation device 102 may determine a local geographical area (e.g., town, city, state, etc.) of its position.

In some embodiments, the persona based recommendation device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

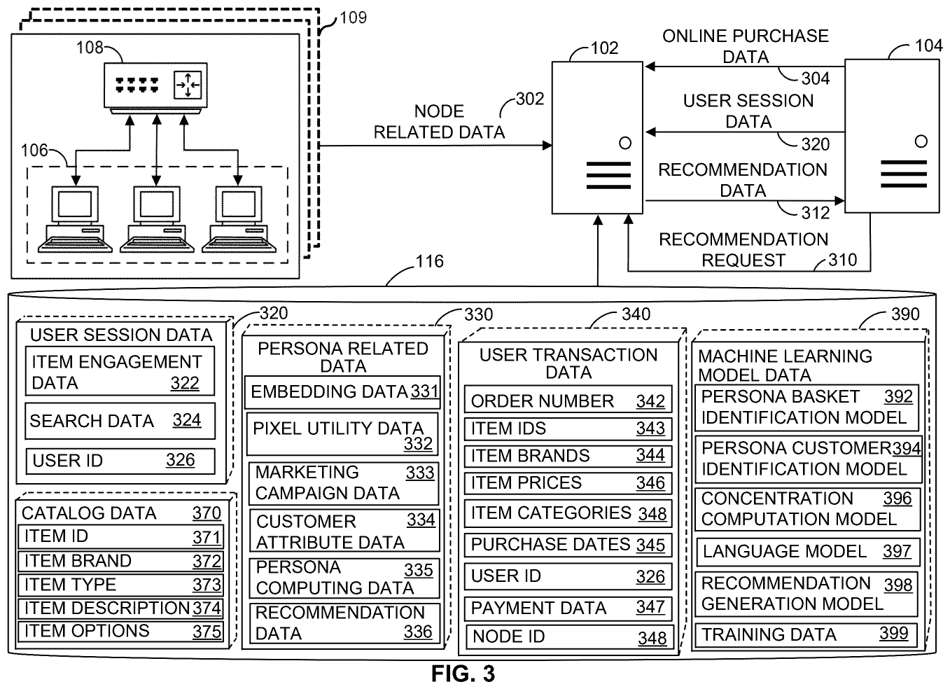

FIG. 3 is a block diagram illustrating various portions of a system for generating and updating a customized marketing campaign, e.g. the system shown in the network environment 100 of FIG. 1, in accordance with some embodiments. As indicated in FIG. 3, the persona based recommendation device 102 may receive user session data 320 from the server 104, and store the user session data 320 in the database 116. The user session data 320 may identify, for each user (e.g., customer, seller, associate), data related to that user's browsing session, such as when browsing a retailer's webpage hosted by the server 104. In some embodiments, the system may not utilize all of the components and data shown in FIG. 3 for generating and updating a customized marketing campaign.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The persona based recommendation device 102 may also receive online purchase data 304 from the server 104, which identifies and characterizes one or more online purchases, such as purchases made by the user and other users via a retailer's website hosted by the server 104. The persona based recommendation device 102 may also receive node related data 302 from the fulfillment nodes 109, which identifies and characterizes one or more in-store purchases, product location data, inventory data, and assortment data related to each of the fulfillment nodes 109. In some embodiments, the node related data 302 may also indicate other information about the fulfillment nodes 109.

The persona based recommendation device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 348 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some embodiments, the database 116 may further store persona related data 330, which may identify data related to persona based recommendations. The persona related data 330 may include one or more of: embedding data 331 identifying embeddings for products and customers for persona related computation, pixel utility data 332 identifying data related to pixel based persona computation and recommendation, marketing campaign data 333 identifying and charactering features and performance of marketing campaigns, customer attribute data 334 indicating customer attributes for persona based recommendations, persona computing data 335 identifying computed persona data (e.g. persona baskets, persona customers, persona concentrations, etc.), and recommendation data 336 indicating recommended market locations and target customers for marketing campaigns.

The database 116 may also store machine learning model data 390 identifying and characterizing one or more models and related data for generating and updating a customized marketing campaign. For example, the machine learning model data 390 may include: a persona basket identification model 392, a persona customer identification model 394, a concentration computation model 396, a language model 397, a recommendation generation model 398 and training data 399. In various embodiments, the machine learning model data 390 includes any number of the persona basket identification models 392, the persona customer identification models 394, the concentration computation models 396, the language models 397 and the recommendation generation models 398.

The persona basket identification model 392 in this example can be used to identify and determine a persona basket including a list of relevant products based on an input query. The input query may be a type of customer persona (e.g., pet owner, sport lover) or a product set or a single type of product. In some embodiments, the persona basket identification model 392 includes one or more large language models for generating a list of products (called persona basket) relevant to the input query, using prompts auto-generated based on the input query.

The persona customer identification model 394 can be used to identify and determine a list of customers having a customer persona associated with a persona basket, e.g. the persona basket identified by the persona basket identification model 392. In some examples, the persona customer identification model 394 includes an embedding matching model that compares embeddings of products in the persona basket and embeddings of customers in a retailer network, to find matches. The matching results can be used to determine the list of customers having a customer persona associated with the persona basket, i.e. having a tendency (or highest likelihood in the customer base) to buy the products in the persona basket. The list of customers may be called persona customers.

The concentration computation model 396 in this example can be used to compute, for each location area (or each pixel), a persona concentration score indicating a concentration of customers of a customer persona in the location area, e.g. based on the customer basket identified by the persona basket identification model 392 and/or the persona customers identified by the persona customer identification model 394. In some embodiments, the concentration computation model 396 can be used to identify or estimate customer locations based on a highest frequency of online order shipping address or a highest frequency of store visits or transactions. The concentration computation model 396 can map the customer locations using pixels, to compute customer concentration in different pixels. While different nodes and stores of a retailer network are located in different pixels, the concentration computation model 396 can also be used to compute customer concentration around each node or store.

The language model 397 may include a natural language model or a large language model, which is used to understand user intent based on a conversation with a user, and/or to achieve any other general-purpose language understanding and generation. In general, a large language model (LLM) can acquire these abilities by learning statistical relationships from text documents during a computationally intensive self-supervised and semi-supervised training process. In some examples, LLMs are artificial neural networks following a transformer architecture. In some embodiments, the language model 397 is used to: understand a query submitted by a user in a conversation with a chatbot, determine whether a persona is existing in a database, and/or create a new persona on-line.

The recommendation generation model 398 in this example can be used to generate recommendation data regarding the customer persona. In some examples, the recommendation generation model 398 is used to generate different recommendation data for different use cases in response to different recommendation requests. For example, the recommendation generation model 398 may be used to rank different pixels or different markets based on their respective persona concentrations regarding a given customer persona, which may be determined based on a product to be sold by a seller, and recommend one or more markets (at pixel level, store level, or node level) that are best suited (e.g. having highest persona concentrations) for selling the product. For example, the recommendation generation model 398 may be used to determine and recommend a list of target customers for a marketing campaign based on a list of filters each associated with a corresponding customer attribute identified based on a query submitted a user.

In some embodiments, one or more of the persona basket identification models 392, the persona customer identification models 394, the concentration computation models 396, the language models 397 and the recommendation generation models 398 can be implemented as a machine learning model. The training data 399 may include data utilized for training one or more of the persona basket identification models 392, the persona customer identification models 394, the concentration computation models 396, the language models 397 and the recommendation generation models 398. In some examples, the training data 399 may be formed based on: item features, store features, customer attribute data, historical transaction data, historical campaign data, historical or labelled persona data, historical or labelled recommendation data, historical feedback data, obtained from either real data or synthetic data.

In some examples, the persona based recommendation device 102 receives a recommendation request 310 from the server 104. The recommendation request 310 may be associated with a query and contextual information obtained from a conversation with a user, e.g. a seller or advertiser, via a chatbot hosted by the server 104. The persona based recommendation device 102 can determine, e.g. using the language model 397, that the query is seeking to create a new customer segment for a marketing campaign. The persona based recommendation device 102 can determine, based on the recommendation request 310, whether an existing persona is associated with the marketing campaign. When no existing persona is associated with the marketing campaign, the persona based recommendation device 102 may create a new persona and identify corresponding persona customers by: determining a persona basket including a list of relevant products based on the recommendation request 310, e.g. using the persona basket identification model 392; and determining a list of customers having a customer persona associated with the persona basket, e.g. using the persona customer identification model 394. In response to the recommendation request 310, the persona based recommendation device 102 generates and transmits the recommendation data 312 to the server 104, e.g. using the recommendation generation model 398. The recommendation data 312 may include recommendations for optimizing market locations for selling products (including new products that have no or little sale history), or recommendations for identifying target customers for a marketing campaign (regarding a given or estimated customer persona).

In some embodiments, the persona based recommendation device 102 may assign one or more of the above described operations to a different processing unit or virtual machine hosted by one or more processing devices 120. Further, the persona based recommendation device 102 may obtain the outputs of the these assigned operations from the processing units, and generate the recommendation data 312 based on the outputs.

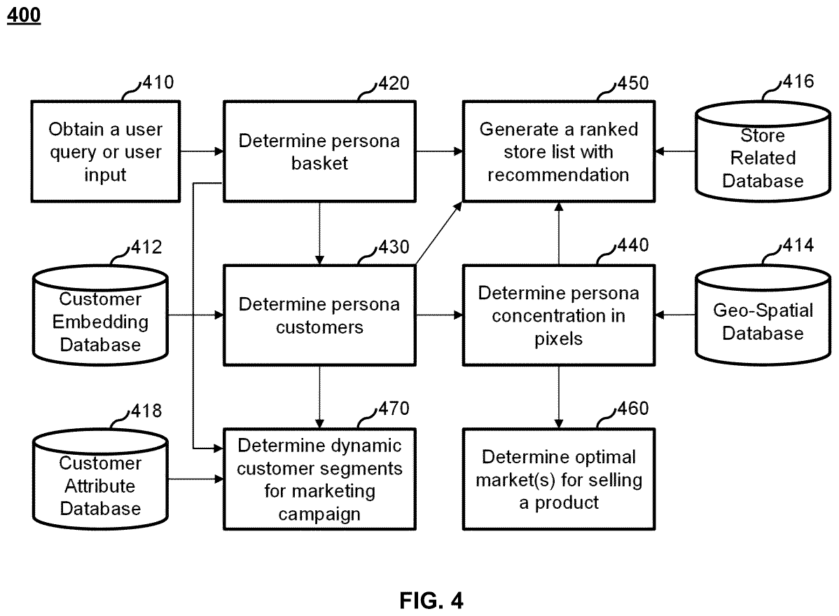

FIG. 4 illustrates an example process 400 for performing persona based recommendation, in accordance with some embodiments. In some embodiments, the process 400 can be carried out by a system including one or more computing devices, such as the persona based recommendation device 102, the server 104, and/or the cloud-based engine 121 of FIG. 1.

As shown in FIG. 4, the process 400 starts from operation 410, where a user query or user input is obtained. In some embodiments, a user (e.g. a seller, a retail associate, an advertiser, etc.) can input, via a user device (e.g. one of the user computing devices 110, 112, 114), a query to understand geo-demand for a specific set of products or a specific type of customers. The query may trigger a recommendation request seeking either store assortment management or market location recommendation. In some embodiments, the recommendation request may also be triggered by a user input, e.g. a user click showing an interest to sell a product, a user action showing an interest of an assortment of a store or node, etc.

At operation 420, the system can determine a persona basket based on the obtained query or input. In some embodiments, the system can identify a list of relevant products (called persona basket) associated with the query using recurring LLM calls. The list of relevant products may be treated as products likely to be included in a shopping basket for customers having a specific persona (e.g. pet owner, sport lover, new mom, etc.). In some examples, the system may determine one or more persona baskets based on the query at the operation 420.

At operation 430, the system may perform a real time identification of a customer base associated with the query using LLM and pre-created customer embeddings from a customer embedding database 412. The customer embedding database 412 may be a standalone database or part of the database 116. The customer embeddings may be pre-created from all customer data available in an eco-system of a retailer. The customer base identified at the operation 430 includes a list of customers (called persona customers) having a customer persona (e.g. pet owner, sport lover, new mom, etc.) associated with the persona basket.

Then the system can map the identified persona customers in pixels at operation 440, by computing persona concentration in each pixel. Each pixel may correspond to a respective geo-location area on a map such that the pixels can cover the map seamlessly. The pixels can be determined by some geo-spatial indexes from a geo-spatial database 414, which may be a standalone database or part of the database 116. In some embodiments, the size of each pixel is configurable based on a distribution of nodes in a retailer fulfillment network of the retailer associated with the system. In some embodiments, the system computes, for each pixel at the operation 440, a persona concentration score indicating a concentration of customers having the customer persona in the pixel.

Then the system can create recommendations for different use cases in response to different types of recommendation requests. For example, at operation 450, the system computes an assortment score for each store (or node), and generates a ranked list of stores based on their assortment scores, when the recommendation request is seeking store assortment management. In some embodiments, for each store, the system computes an assortment score for the store based on the data determined at the operations 420˜440 and data (e.g. current assortment data) related to the store from a store related database 416, which may be a standalone database or part of the database 116. In some embodiments, the assortment score may be updated by: computing an average assortment score for two or more nearest stores to the store, computing an initial assortment gap for the store based on the assortment score and the average assortment score, computing an updated assortment score for the store based on the initial assortment gap and an average of persona concentrations in nearest pixels of the store. In some embodiments, a store having a low assortment score means the store has under-assorted products (i.e. products having an assortment gap, especially compared to nearby stores) regarding a given persona, e.g. the persona associated with the obtained query or the determined persona basket. Based on the ranked list of stores, the system can apply a threshold to identify under-assorted stores and recommend them to improve assortment of those under-assorted products regarding the given persona.

At operation 460, the system may determine optimal market(s) for selling a product, when the recommendation request is seeking market location recommendation. In general, sellers can pick where they want to sell, in consideration of various factors, lie delivery cost and shipping cost, related to different regions and markets. In some embodiments, the product is a cold-start product having no or little sale history, and a seller is trying to select one or more pixels to sell this product in the selected pixels, or limit online order delivery to the selected pixels. The system can rank different pixels based on their respective persona concentration scores associated with the obtained query or the determined persona basket, and recommend the top ranked pixels to the seller. In this situation, the determined persona basket at the operation 420 would include a list of products relevant to the product, e.g. based on product embeddings or a likelihood that the product would be included in a same shopping basket as the list of products associated with a persona.

At operation 470, the system may determine dynamic customer segment(s) for a given marketing campaign or campaign idea, when the recommendation request is seeking recommendation for target customers to promote one or more products. For example, a seller may have an idea of creating a marketing campaign for a persona, and therefore send a query via a chatbot. If the persona already exists, the system can directly determine target customers at the operation 470 belonging to this persona, e.g. based on the results generated by the operation 430 or persona customer data in a database. If the persona does not exist, the system can perform the operations 420 and 430 to create a new persona with corresponding persona customers, and then determine at the operation 470 the customer segments including target customers associated with the new persona for the marketing campaign.

In some embodiments, the customer segments are determined based on a customer attribute database 418, which may be a standalone database or part of the database 116. In some embodiments, the customer attribute database 418 may include customer attributes like: demographics, profile, site actions, online transactions, in-store transactions, customer relationship management (CRM), etc. In some embodiments, the customer segments are determined dynamically based on interactions between the seller and the chatbot. For example, the system can provide filters each associated with a corresponding customer attribute to the seller via the chatbot. The seller can select one or more of the filters to dynamically limit or modify the customer segments related to the marketing campaign. In some embodiments, the marketing campaign is associated with one or more pixels specified by the seller or determined by the system. In that scenario, the system can make use of the geo-spatial indexes from the geo-spatial database 414 when determining the dynamic customer segments for the marketing campaign at the operation 470.

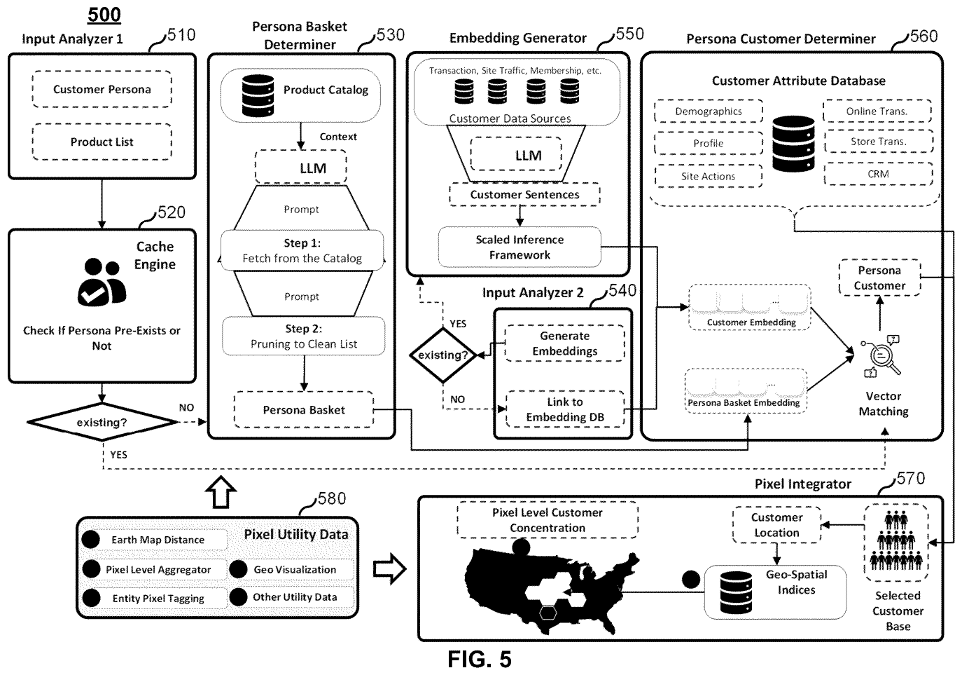

FIG. 5 illustrates an example architecture of a system 500 for recommending market locations and store assortment, in accordance with some embodiments. In some embodiments, the system 500 can be implemented by one or more computing devices, such as the persona based recommendation device 102, the server 104, and/or the cloud-based engine 121 of FIG. 1 and FIG. 3.

As shown in FIG. 5, the system 500 includes an input analyzer 1 510, a cache engine 520, a persona basket determiner 530, an input analyzer 2 540, an embedding generator 550, a persona customer determiner 560, and a pixel integrator 570. The input analyzer 1 510 may receive and analyze user inputs from a user, e.g. a query input by a user. In some examples, the input analyzer 1 510 can determine or extract a customer persona from the query. In some examples, the input analyzer 1 510 can determine or extract a product list from the query.

The cache engine 520 in this example can validate whether a persona, e.g. the customer persona extracted from the query or a customer persona associated with the product list extracted from the query, pre-exists or not. If it is determined the persona pre-exists, e.g. in a persona database of the retailer, then the cache engine 520 will send the persona directly to the persona customer determiner 560 to determine persona customers having the persona. If it is determined the persona does not pre-exist, then the cache engine 520 will forward the analyzed query to the persona basket determiner 530 to determine a persona basket based on the query obtained by the input analyzer 1 510.

As shown in FIG. 5, the persona basket determiner 530 may generate context based on a product catalog and the query, and utilize an LLM based on the context to generate the persona basket. The persona basket may include a list of relevant products based on the query. For example, the persona basket determiner 530 can generate and input a first prompt to the LLM to fetch a first list of products from the product catalog. Then, the persona basket determiner 530 can generate and input a second prompt to the LLM to prune and clean the first list to determine the list of relevant products in the persona basket. The persona basket determiner 530 can send the persona basket to the persona customer determiner 560 to determine a persona basket embedding for persona customer determination.

The input analyzer 2 540 in this example, may receive and analyze user inputs from a customer, e.g. an action performed by a customer during a transaction, an online activity performed by a customer via a website or API. In some examples, the input analyzer 2 540 generates an embedding for the customer and determine whether this is an existing customer or not. If it is determined the customer is not pre-existing, e.g. in a customer database of the retailer, then the newly generated embedding for the customer will be linked to an embedding database, which may be a standalone database or part of the database 116. If it is determined the customer is pre-existing for the retailer, then the input analyzer 2 540 will send the customer ID (with input data of the customer) to the embedding generator 550 to generate a customer embedding for the customer based on existing data of the customer. In some embodiments, the customer embeddings are created for each customer ID.

As shown in FIG. 5, the embedding generator 550 may obtain customer data of different customers (including the customer identified by the input analyzer 2 540) from various data sources (e.g. transaction data, site traffic, membership data, etc.), and utilize an LLM based on the customer data to generate customer sentences. The embedding generator 550 can input the customer sentences to a scaled inference framework to generate a customer embedding for the customer, in view of other embeddings for other customers.

The persona customer determiner 560 in this example may obtain customer embeddings from the embedding generator 550 and/or the embedding database in the input analyzer 2 540. The persona customer determiner 560 may also generate or obtain a persona basket embedding for the persona basket determined by the persona basket determiner 530. In some embodiments, both the customer embeddings and the persona basket embeddings are all vectors in a high-dimensional space. The persona customer determiner 560 can perform a vector matching between the persona basket embedding for the persona basket determined by the persona basket determiner 530 and the customer embeddings of all customers of the retailer, to find matching customer embeddings and corresponding customers. These matching customers are persona customers associated with the persona basket determined by the persona basket determiner 530.

In the example shown in FIG. 5, the persona customer determiner 560 can send data related to the persona customers (e.g. persona customer IDs, customer attributes from a customer attribute database) to the pixel integrator 570 to map customers in pixels. The customer attribute database may be a standalone database or part of the database 116, and may include customer attributes like: demographics, profile, site actions, online transactions, in-store transactions, customer relationship management (CRM), etc.

The pixel integrator 570 in this example can determine a selected customer base, using the data received from the persona customer determiner 560. For example, the pixel integrator 570 can determine a list of persona customers having a given customer persona, e.g. the persona associated with the persona basket determined by the persona basket determiner 530. Based on the customer attributes (e.g. transaction data) obtained from the persona customer determiner 560, the pixel integrator 570 can also determine customer locations for the list of persona customers. Then, utilizing some geo-spatial indices for pixels on a map, the pixel integrator 570 can compute, for each pixel on the map, a persona concentration score indicating a concentration of persona customers having the given customer persona in the pixel. The pixel integrator 570 can provide a visualization of the pixels in the map with different pixels presented with different visualization modes (e.g. colors, patterns, etc.) based on their respective persona concentration scores.

In some embodiments, the system 500 can utilize pixel utility data 580 in one or more components of the system 500. The pixel utility data 580 in this example may be stored in a standalone database or in the database 116, and include data related to: earth map distance, pixel level aggregator, entity pixel tagging, geo visualization, and other utility data. For example, the pixel integrator 570 can use the geo visualization and the pixel level aggregator from the pixel utility data 580 to generate a pixel level customer concentration map, as discussed above.

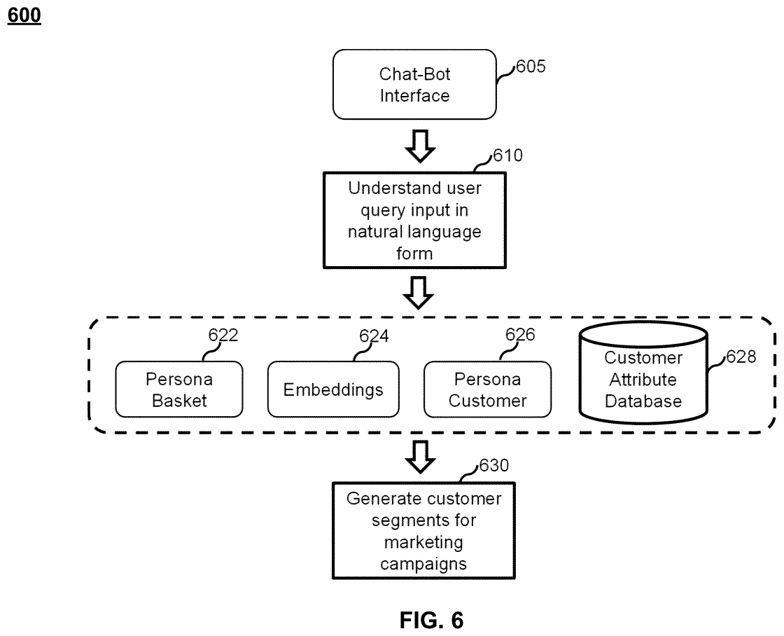

FIG. 6 illustrates an example process 600 for customizing a marketing campaign, in accordance with some embodiments. In some embodiments, the process 600 can be implemented as part of the operation 470 in FIG. 4. In some embodiments, the process 600 can be carried out by a system including one or more computing devices, such as the persona based recommendation device 102, the server 104, and/or the cloud-based engine 121 of FIG. 1.

As shown in FIG. 6, the process 600 starts from operation 610, where the system understands a user query input in natural language form, via a chat-bot interface 605. For example, a seller may input a query in natural language form associated with a marketing campaign, seeking target customers who are likely to be interested in products promoted by the marketing campaign. The system may use a language model, e.g. the language model 397, to understand the seller's intent through the user query at the operation 610.

Based on the understanding of the user query, the system can make use of various data to generate customer segments for the marketing campaign at operation 630. For example, the system may create a new persona based on the user query which merely indicates an idea or intention of the marketing campaign. In some embodiments, the new persona may be generated based on a persona basket 622, embeddings 624, and persona customers 626. The persona basket 622 may be determined as in the operation 420 in FIG. 4, or by the persona basket determiner 530 in FIG. 5. The embeddings 624 may be generated by the input analyzer 2 540 in FIG. 5. The persona customers 626 may be determined as in the operation 430 in FIG. 4, or by the persona customer determiner 560 in FIG. 5. In some embodiments, the user query indicates a persona that is already existing or pre-determined, such that the system can directly retrieve data about the existing persona, e.g. from a persona database which may be a standalone database or part of the database 116.

After creating or retrieving the relevant persona, the system may generate and recommend the target customer segments selected from customers belonging to this persona for the marketing campaign at the operation 630. The target customer segments are target customers who are determined to be interested in products promoted by the marketing campaign and satisfy criteria set by one or more filters. The one or more filters may be auto-generated by the system in response to the user query, based on customer attributes in a customer attribute database 628, which may be a standalone database or part of the database 116. In some embodiments, the customer attribute database 418 may include customer attributes like: demographics, profile, site actions, online transactions, in-store transactions, customer relationship management (CRM), etc.

In some embodiments, the seller may start to run the marketing campaign against the target customer segments generated and recommended by the system. In some embodiments, the seller may further input some criteria to modify or limit the target customer segments generated and recommended by the system, before running the marketing campaign. In some embodiments, the seller may further input some criteria to modify or limit the target customer segments generated and recommended by the system, after running the marketing campaign. When receiving further inputs from the seller, the system can generate or provide more filters for the seller to select to tune the target customer segments for the marketing campaign.

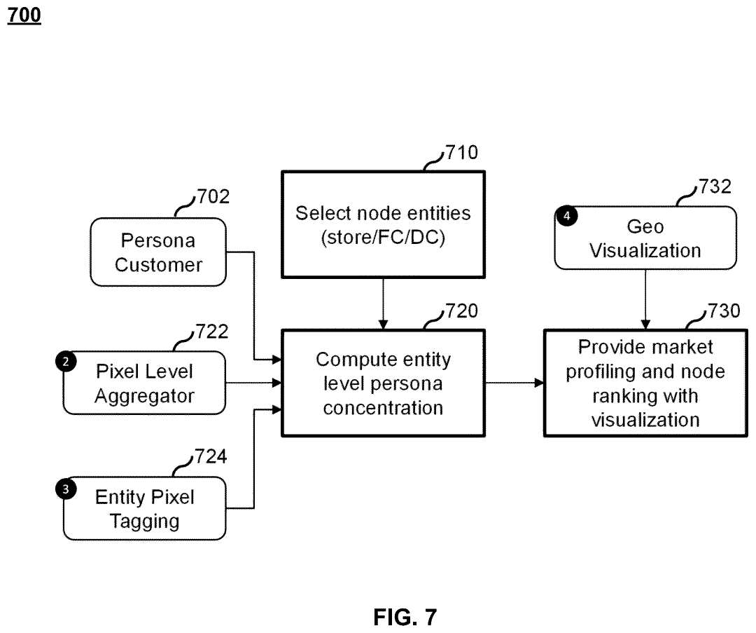

FIG. 7 illustrates an example process 700 for recommending market locations, in accordance with some embodiments. In some embodiments, the process 700 can be implemented as part of the operation 460 in FIG. 4. In some embodiments, the process 700 can be carried out by one or more computing devices, such as the persona based recommendation device 102, the server 104, and/or the cloud-based engine 121 of FIG. 1.

As shown in FIG. 7, the process 700 starts from operation 710, where the system selects node entities (e.g. stores, distribution centers, fulfillment centers), e.g. based on a recommendation request seeking optimal markets to sell a product. Then at operation 720, the system can compute an entity level persona concentration based on the selected node entities, regarding persona customers 702 that are determined based on the product, e.g. by the persona customer determiner 560 in FIG. 5 as discussed above. In this example, the operation 720 is performed using the pixel level aggregator 722 and the entity pixel tagging 724, both of which may be part of the pixel utility data 580 in FIG. 5.

At operation 730, the system provides market profiling and node ranking with visualization, based on the entity level persona concentration and geo visualization data 732 which may be part of the pixel utility data 580 in FIG. 5. For example, the system can profile different markets (at pixel level, store level, node level, etc.) based on their respective persona concentration scores (e.g. as computed in the operation 440 in FIG. 4 and/or by the pixel integrator 570 in FIG. 5 as discussed above), such that different markets are ranked visually according to their respective persona concentration scores. Based on the visualized market data, the system can recommend one or more markets that are optimal to sell the product or deliver the product, in terms of likely interest from corresponding persona customers.

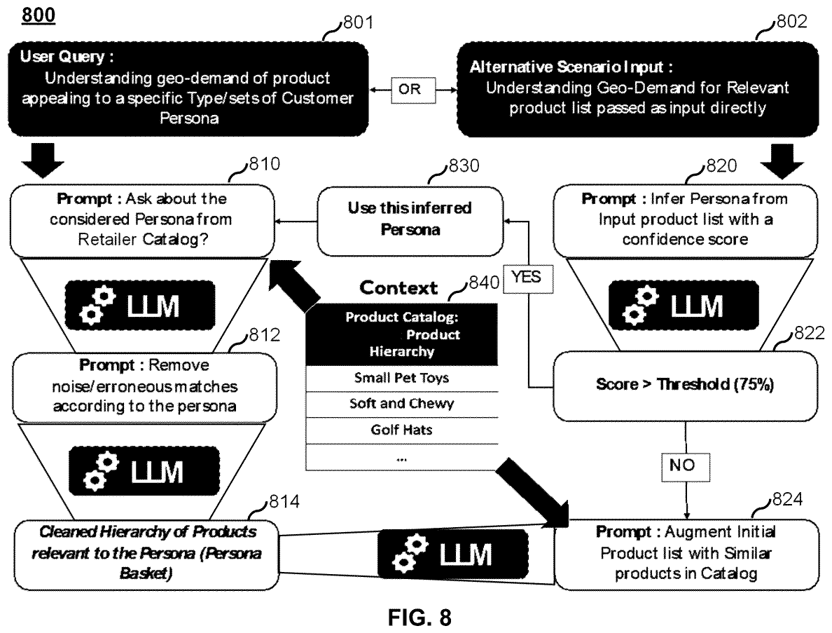

FIG. 8 illustrates an example process 800 for persona basket identification, in accordance with some embodiments. In some embodiments, the process 800 can be implemented as part of the operation 420 in FIG. 4 and/or performed by the persona basket determiner 530 in FIG. 5. In some embodiments, the process 800 can be carried out by a system including one or more computing devices, such as the persona based recommendation device 102, the server 104, and/or the cloud-based engine 121 of FIG. 1.

In some embodiments, the system may receive an input query Q submitted by a user, and produce a persona basket (L_{PB}). As shown in FIG. 8, the input query can be either a query 801 including a type of customer persona Qₚ (e.g., pet owner) or a user input 802 including a product set or a single type of product Qₗ.

In some examples, the system receives the query 801 for understanding geo-demand of product(s) appealing to a specific type or sets of customer persona (i.e. Q=Qₚ). For example, the query 801 may recite: “what is geo-demand for products liked by a pet owner?” In some embodiments, the geo-demand may refer to a number of customers who are in demand of the products in a configured geographical location.

Based on the query 801, the system can generate a prompt at operation 810 to ask an LLM about considered persona from a retailer catalog. For example, the system can use a retailer product catalog L as context 840 and ask the LLM to fetch the relevant products using the context 840 and based on the customer persona Qₚ in the query. In some embodiments, each product has multiple hierarchy information concatenated to it, during the LLM callings. In some examples, the system considers 4 levels in the product hierarchy. For store-related problems, the system considers department category group, category, sub-category and fine-line. Similarly for online data, the system considers department category group, category, sub-category, and product type as the most granular layer.

In some embodiments, there is a token limit for the LLM and it is not sufficient when the context length is long. As such, the system can break each single LLM call into multiple calls performed recursively or in parallel. Then, the system combine them in the end to generate a product list. For example, suppose an LLM call L is broken into u-partitions, L1, L2, . . . , Lu. Then there are u LLM calls, where for the i^{th} call, the system passes Lᵢ as context into the LLM. After the operation 810, the system can get a temporary product List Lₜ, including initial product matches for the considered persona.

Then at operation 812, the system can generate another prompt to remove noise and/or erroneous matches from the temporary product List Lₜ according to the persona. For example, the system can use another LLM call to pass Lₜ and prompt it to clean any noise that might be introduced at the operation 810. The operation 812 works like a guardrail in an automated workflow, to generate a final list of products referred to as L_{PB}, which is persona basket 814 in this example and includes a cleaned hierarchy of products 814 relevant to the persona. In some examples, regarding a query Qₚ for “pet owner,” the temporary product List Lₜ may include: specialty feed, basic feeders, dog and cat repellent, pup soft & chewy, pet life vests, cat flea and tick collars, training aids pads, pet beds, toddler beds, toy dog. After cleaning at the operation 812, the final list L_{PB} may prune out the “toddler beds” and “toy dog,” since they are not for pet owners but may be included due to language similarity and mistakenly fetched by LLM. As such, a persona is used to capture latent information of customers, which is not explicitly available in the data but hidden in terms of their purchase behaviours.

In some examples, the system receives the query 802 for understanding geo-demand of relevant product list which is passed directly as input (i.e. Q=Ql). For example, the query 802 may recite: “what is geo-demand for pet toys and pet beds?” Based on the query 802, the system can generate a prompt at operation 820 to ask the LLM to infer persona from the input product list with a confidence score. For example, the system can first use a LLM call to identify persona that might be interested in purchasing these products and a confidence score (Cₛ).

At operation 822, the system can compare the confidence score to a predetermined threshold t*, which may be pre-defined to be e.g. 75%, 80% or 90%. If Cₛ>t* at the operation 822, then the process proceeds to the operation 810, through the operation 830 where the inferred persona from the operation 820 is used as a new query Qₚ at the operation 810, to eventually generate the persona basket 814, in the manner described above.

Otherwise, if Cₛ<=t at the operation 822, the process goes to operation 824, where the system can generate another prompt to augment the initial product list input by the user with similar products in the product catalog. For example, the system can use the initial product list Qₗ as a query and ask the LLM to find similar products giving L₁, L₂, . . . , Lᵤ as context recursively or in parallel as discussed above. A combined output of these LLM calls can be treated as the persona basket 814, i.e., L_{PB}.

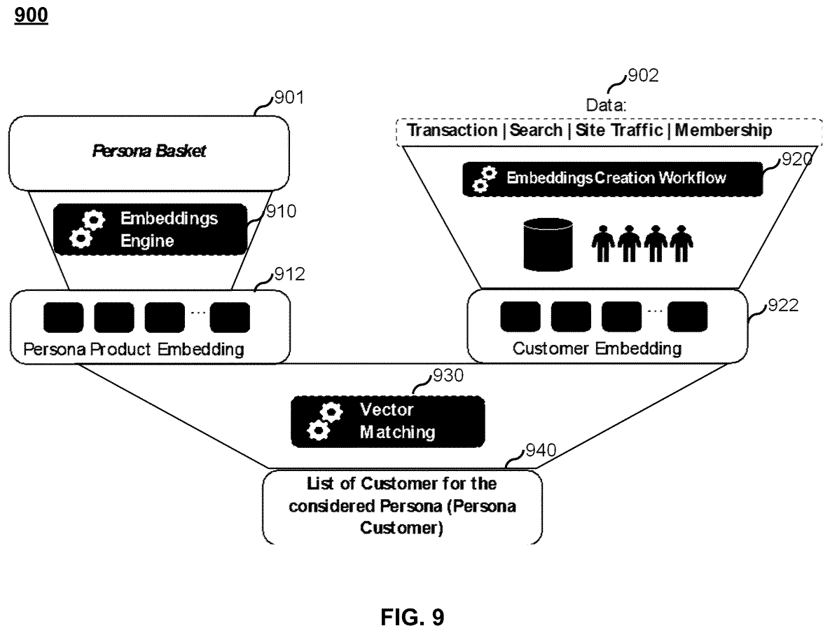

FIG. 9 illustrates an example process 900 for persona customer identification, in accordance with some embodiments. In some embodiments, the process 900 can be implemented as part of the operation 430 in FIG. 4 and/or performed by the embedding generator 550 and the persona customer determiner 560 in FIG. 5. In some embodiments, the process 900 can be carried out by a system including one or more computing devices, such as the persona based recommendation device 102, the server 104, and/or the cloud-based engine 121 of FIG. 1.

As shown in FIG. 9, the process 900 starts from generating persona product embeddings 912 and customer embeddings 922 in parallel. One purpose of the process 900 is to find customers relevant to a persona in a query or derived from the query.

To generate the persona product embeddings 912, the system can take the persona basket (L_{PB}) 901 as input and create an embedding out of it using an embeddings engine 910, which has an embedding inference framework as discussed above. In some embodiments, each persona product embedding may be a high-dimensional vector, e.g. having more than 700 dimensions, referred to as E_{Q}.

To generate the customer embeddings 922, the system can take the customer data (e.g. transaction data, search data, site traffic data, membership data, etc.) 902 as input and create the customer embeddings 922 using an embedding creation workflow 920, e.g. by the embedding generator 550 in FIG. 5 as discussed above. In some embodiments, each customer embedding may also be a high-dimensional vector, e.g. having a same or similar dimension as the persona product embeddings, referred to as E₁, E₂, E₃, . . . , E_{N}.

Then the system can compare each persona product embedding E_{Q} with all customer embeddings E₁, E₂, E₃, . . . , E_{N}, e.g. using a vector matching algorithm 930, to find the persona customers 940, as a list of customers for the considered persona. For example, the system can use a cosine distance metric considering the dimension of the vector embeddings, to find the matches. For example, every customer in the persona customers 940 corresponds to a customer embedding having a cosine distance smaller than a threshold to the persona product embedding E_{Q} or having a cosine similarity larger than a threshold compared to the persona product embedding E_{Q}. In some embodiments, the output of the process 900, persona customers 940, is in form of a set of customer IDs referred as C_{PB}={Cₖ₁, Cₖ₂, . . . , Cₖₙ}.

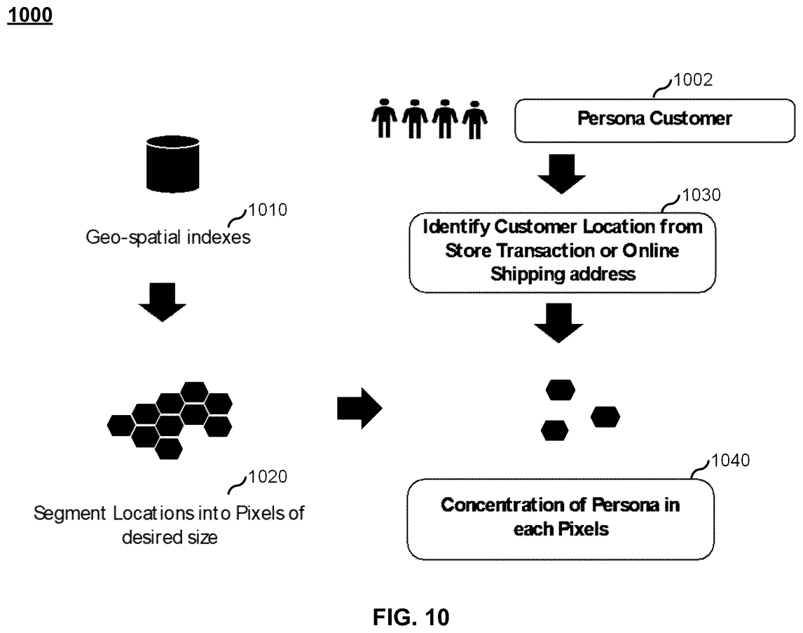

FIG. 10 illustrates an example process 1000 for computing persona concentration in pixels, in accordance with some embodiments. In some embodiments, the process 1000 can be implemented as part of the operation 440 in FIG. 4 and/or performed by the pixel integrator 570 in FIG. 5. In some embodiments, the process 1000 can be carried out by a system including one or more computing devices, such as the persona based recommendation device 102, the server 104, and/or the cloud-based engine 121 of FIG. 1.

One purpose of the process 1000 is to compute a concentration of persona customers C_{PB} in each pixel. As shown in FIG. 10, the process 1000 starts from segmenting locations into pixels of a desired size at operation 1020 based on geo-spatial indexes 1010. Each pixel may be a unit of market size, which is configurable depending on store distribution of the retailer and customer distribution data of the retailer. Each pixel corresponds to a location area on a map, and an index for each pixel can be determined given the latitude and longitude of the pixel. The operation 1020 can be performed offline, before receiving any user query.

At operation 1030, the system can identify or estimate customer location for the persona customers 1002 based on their store transactions or online shipping addresses. The persona customers 1002 may be determined based on the process 900 as discussed above. The customer location may be estimated based on most frequently used online order shipping address or most frequently visited store address for each customer in the persona customers 1002. Then the system can map the estimated customer locations to the pixels.

At operation 1040, the system can integrate the geo-spatial indexes with the customer location data, and map customers Cᵢ to pixels Pⱼ, where i is any integer from 1 to N (for N customers) and j is any integer from 1 to k (for k pixels). Then for each Pⱼ, the system can compute Dⱼ (number of customers in a pixel Pⱼ), Nⱼ (number of customers in the pixel Pⱼ and belonging to the persona customers C_{PB}) and Rⱼ (a concentration of persona customers in each given pixel Pⱼ) according to the following equations.

$${D}_{j} = {\sum }_{i = 1}^{N} I ( {C}_{i} ∈ {P}_{j} ) , ∀ j = 1 ( 1 ) k$$

$${N}_{j} = {\sum }_{i = 1}^{N} I ( ( {C}_{i} ∈ {P}_{j} ) ⋂ ( {C}_{i} ∈ {C}_{P B} ) ) , ∀ j = 1 ( 1 ) k$$

$${R}_{j} = {N}_{j} / {D}_{j} , ∀ j = 1 ( 1 ) k$$

Indicator function, I(x)=1 if x is True else I(x)=0.

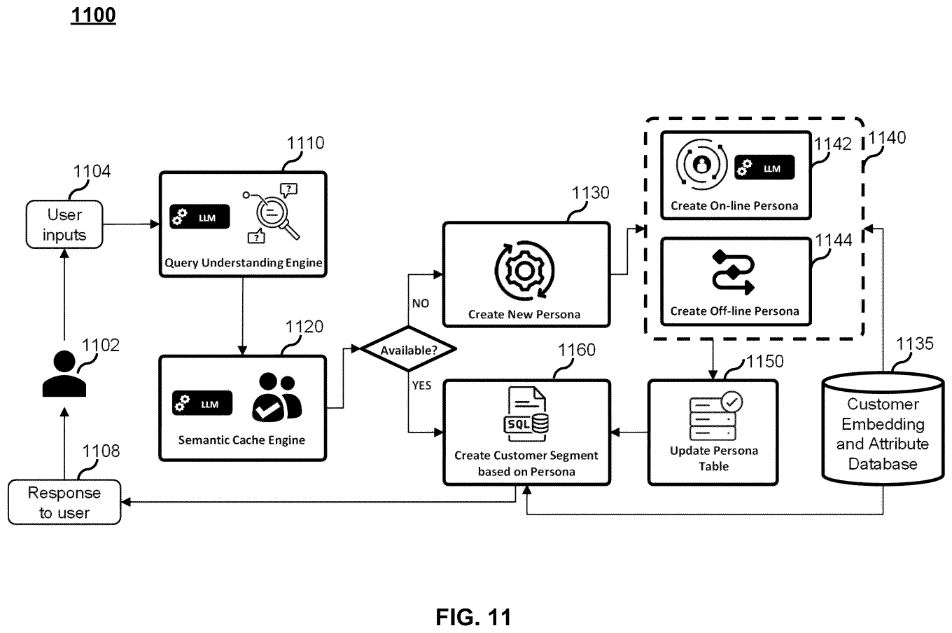

FIG. 11 illustrates an example process 1100 for generating a customer segment for a marketing campaign, in accordance with some embodiments. In some embodiments, the process 1100 can be implemented as part of the operation 470 in FIG. 4. In some embodiments, the process 1100 can be carried out by a system including one or more computing devices, such as the persona based recommendation device 102, the server 104, and/or the cloud-based engine 121 of FIG. 1.

One purpose of the process 1100 is to generate a customer segment including target customers for a marketing campaign, in response to one or more queries submitted by a user 1102. As shown in FIG. 11, the process 1100 starts from operation 1110, where the system utilizes a query understanding engine to analyze user inputs 1104 from the user 1102, and determines intent of the user 1102. For example, the query understanding engine may analyze the user inputs 1104 based on an LLM, e.g. the language model 397. In some embodiments, the query understanding engine also converts the user inputs 1104 from a format (e.g. utterance, natural language) input by the user 1102 to a format (e.g. a text format, a data-interchange format) readable by other components of the system. This generates queries in formats that can be processed by the system.

Then at operation 1120, the system can utilize a semantic cache engine to validate whether a persona, e.g. a persona indicated by a query extracted from the user inputs 1104 or a persona associated with a marketing campaign identified by the query, pre-exists or not. If it is determined the persona pre-exists, e.g. in a persona database of a retailer, then the semantic cache engine will send the persona directly to operation 1160 to create a customer segment based on the persona for the marketing campaign. If it is determined the persona does not pre-exist, then the semantic cache engine will forward the analyzed query to operation 1130 to create a new persona based on the query.

In some embodiments, the system can generate context based on the query, and utilize an LLM based on the context to generate a persona basket at the operation 1130. The persona basket may include a list of relevant products based on the query, e.g. as performed by the persona basket determiner 530 in FIG. 5.

As shown in FIG. 11, the system can perform operation 1140 to create a new persona associated with a list of customers having this new persona. The system may create the new persona on-line at operation 1142 or off-line at operation 1144. For example, the system may obtain customer embeddings from a customer embedding and attribute database 1135, which may be a standalone database or part of the database 116. The system may also generate or obtain a persona basket embedding for the persona basket determined at the operation 1130. In some embodiments, both the customer embeddings and the persona basket embeddings are all vectors in a high-dimensional space. The system can perform a vector matching between the persona basket embedding for the persona basket determined at the operation 1130 and the customer embeddings of all customers of the retailer, to find matching customer embeddings and corresponding customers. These matching customers are persona customers associated with the persona basket and the newly-created persona indicated by the persona basket. In some embodiments, the newly-created persona and its associated persona customers are determined similar to the operations performed by the input analyzer 2 540, the embedding generator 550 and the persona customer determiner 560 in FIG. 5.

At operation 1150, the system may update a persona database, e.g. a persona table, based on the newly-created persona and its associated persona customers. Then at operation 1160, the system creates a customer segment based on the newly-created persona for the marketing campaign. In some embodiments, the customer segment includes all persona customers associated with the newly-created persona in the persona database. In some embodiments, the customer segment includes a portion of the persona customers associated with the newly-created persona in the persona database. The portion of the persona customers may be selected based on additional user inputs, previous user inputs, or a user profile of the user 1102.

In some examples, the system may generate a list of filters each associated with a corresponding customer attribute that is related to the query and extracted from the customer embedding and attribute database 1135. After creating the new persona, the system can provide at least part of the filters to the user 1102 as part of a response 1108 to the user 1102. Then based on additional user inputs of the user 1102, the system can select target customers for the marketing campaign from the persona customers associated with the newly-created persona. The system may also apply additional filters related to location, store, seller preference, etc., for the user 1102 to further modify or limit the target customers for the marketing campaign.

In some examples, the system may automatically generate a list of filters based on the query and previous user inputs and context of the user-chatbot conversation. For example, a previous user input may indicate that the user is trying to sell a specific product during Christmas season. After the system has received the query from the user to create a marketing campaign to promote the specific product, the system can generate a filter related to shopping season, for the user to directly select Christmas season to filter the target customers. In some examples, the system can directly apply a filter (e.g. Christmas season) onto the target customers, and provide the filtered results to the user with an indication that the filter has been applied. The user may have an option to remove that filter to obtain unfiltered results.

In some examples, the system may automatically generate a list of filters based on the query and a user profile of the user 1102. For example, the user profile of the user 1102 may indicate that the user 1102 is merely selling products in a specific location or pixel. After the system has received the query from the user to create a marketing campaign to promote products, the system can generate a filter related to market locations or pixels, for the user to directly select the specific location or pixel to filter the target customers. In some examples, the system can directly apply the location filter onto the target customers, and provide the filtered results to the user with an indication that the filter has been applied. The user may have an option to remove that filter to obtain unfiltered results.

The customer segment created at the operation 1160 after applying applicable filters based on user inputs, can be provided as part of the response 1108 to the user 1102. In some embodiments, the user 1102 may provide feedback or additional user inputs to the system to: further customize the marketing campaign with additional conditions based on campaign performance, update the customized marketing campaign, create another marketing campaign, etc.

In some embodiments, the operations 1130, 1142, 1144 are performed asynchronously; while the operation 1160 is performed synchronously. In some embodiments, the response 1108 sent to the user 1102 is a response to a user query and includes: the customer segment created at the operation 1160, a request ID associated with the user query, and metadata related to the marketing campaign.

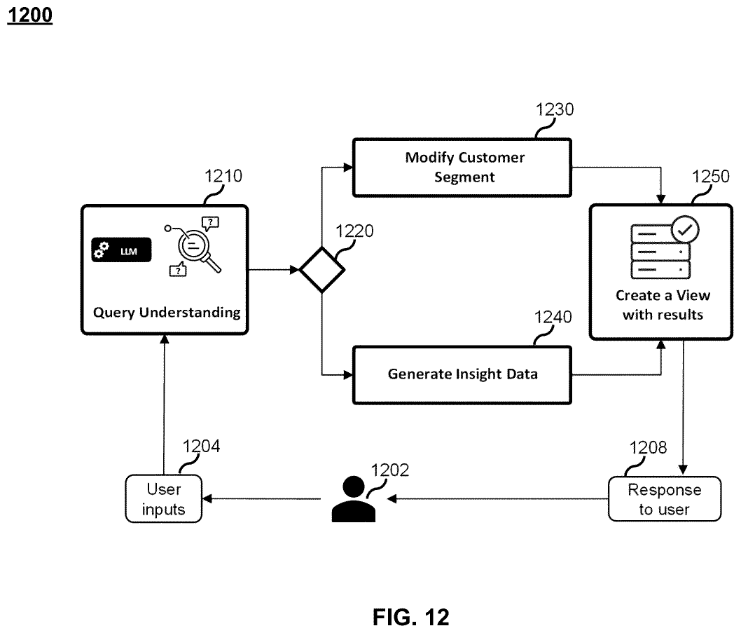

FIG. 12 illustrates an example process 1200 for modifying a customer segment for a marketing campaign, in accordance with some embodiments. In some embodiments, the process 1200 can be implemented as part of the operation 470 in FIG. 4. In some embodiments, the process 1200 can be carried out by a system including one or more computing devices, such as the persona based recommendation device 102, the server 104, and/or the cloud-based engine 121 of FIG. 1.

One possible purpose of the process 1200 is to modify a customer segment including target customers for a marketing campaign, in response to one or more queries submitted by a user 1202. Another possible purpose of the process 1200 is to provide insights about the customer segment and/or the marketing campaign in response to one or more queries submitted by the user 1202, for the user 1202 to easily understand the generated campaign and customer segment.

As shown in FIG. 12, the process 1200 starts from operation 1210, where the system utilizes a query understanding engine (which may be the same query understanding engine as in the operation 1110) to analyze user inputs 1204 from the user 1202, and determines intent of the user 1202. For example, the query understanding engine may analyze the user inputs 1204 based on an LLM, e.g. the language model 397. In some embodiments, the query understanding engine also converts the user inputs 1204 from a format (e.g. utterance, natural language) input by the user 1102 to a format (e.g. a text format, a data-interchange format) readable by other components (e.g. LLM) of the system. This generates queries in formats that can be processed by the system.

At operation 1220, the system classifies each query generated from the user inputs 1204 into different classes based on the user intent determined by the query understanding engine. In some examples, a query may be classified as a modify query request to modify a previously created customer segment for a marketing campaign, and the process 1200 will go to operation 1230 to modify the customer segment. In some examples, a query may be classified as an insight query request to understand insight of the previously created customer segment, and the process 1200 will go to operation 1240 to generate insight data about the customer segment.

At the operation 1230, the system may update the previously created customer segment based on user selections of filters or additional user inputs, e.g. after the user 1202 selects a location, a pixel, and/or a shopping season associated with the marketing campaign, or after the user 1202 inputs additional idea related to the target customers and/or the marketing campaign. These user selections or inputs may be received right after the previously created customer segment is provided to the user 1202, or after the user 1202 runs the marketing campaign for a time period based on the previously created customer segment. In some embodiments, the customer segment is updated at the operation 1230 without changing the persona created or retrieved for the marketing campaign.

At the operation 1240, the system may generate insight data about the previously created customer segment based on additional user inputs, e.g. after the user 1202 asks about a distribution, some statistics, or other data related to the previously created customer segment. These user inputs may be received right after the previously created customer segment is provided to the user 1202, or after the user 1202 runs the marketing campaign for a time period based on the previously created customer segment.

The system may gather results from the operations 1230, 1240, and create a view at operation 1250 to show the results, e.g. via a chatbot interface, to the user 1202. In some embodiments, the system sends the results to the user 1202 as part of a response 1208 to a user query generated from the user inputs 1204. In some embodiments, the response 1208 sent to the user 1202 includes: the results from the operation 1230 or the operation 1240, a request ID associated with the user query, and metadata related to the customer segment or the marketing campaign. For example, the metadata may include an output table name and data related to an insight of the customer segment.

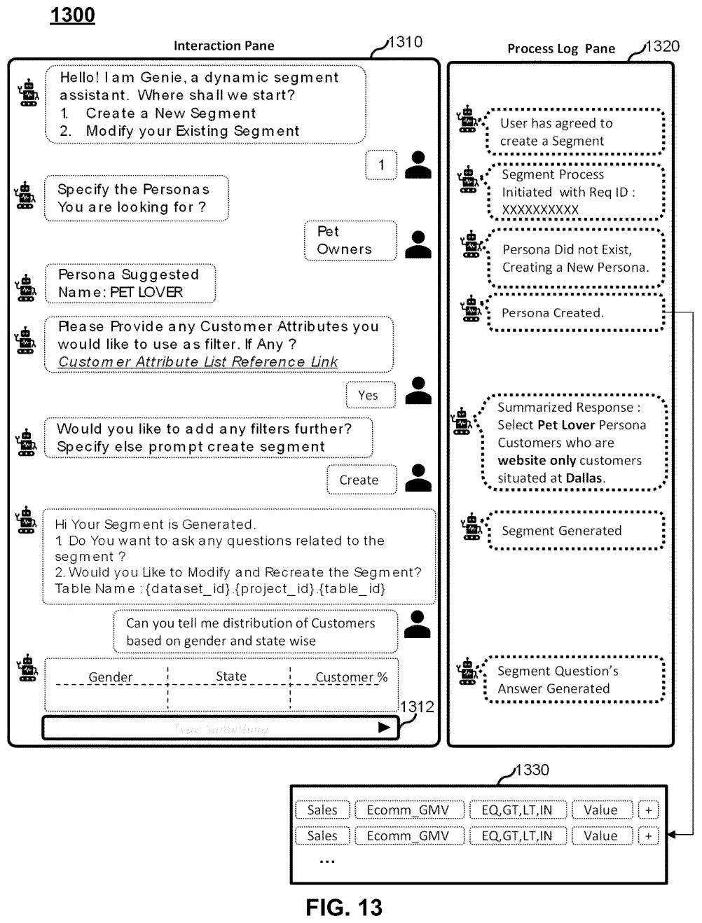

FIG. 13 illustrates an example frame 1300 for generating a customer segment for a marketing campaign, in accordance with some embodiments. In some embodiments, the frame 1300 corresponds to a conversion between a user and a chatbot hosted by a server, e.g. the server 104. In some embodiments, the frame 1300 can be implemented by a system including one or more computing devices, such as the persona based recommendation device 102, the server 104, and/or the cloud-based engine 121 of FIG. 1.

As shown in FIG. 13, the frame 1300 includes: an interaction pane 1310 showing a front-end conversation between a user and a chatbot, and a process log pane 1320 showing back-end operation records in a process of the system while having the conversation. The user may be a seller, an advertiser, a sponsor, or anyone who is interested in customizing a marketing campaign. The interaction pane 1310 may be displayed to the user, e.g. on a user device of the user, while the user is having the conversation with the chatbot. The interaction pane 1310 in this example includes an input window 1312 for the user to type any text reflecting: e.g. a query, a question, a request, or a selection. In some embodiments, the user may provide these inputs via utterance using a microphone.

The conversation in the example shown in the interaction pane 1310 starts from an introduction of the chatbot to the user. As shown in FIG. 13, the chatbot provides two options to the user: “1. Create a New Segment,” and “2. Modify your Existing Segment.” The user in this example selects the first option by inputting “1.” In some embodiments, the user can also directly type “Create a New Segment” or “New Segment” to select the first option. Correspondingly at the back-end, the process log pane 1320 may record that: the user has agreed to create a segment, and a segment process is initiated with a request ID.

As shown in FIG. 13, the chatbot then asks the user to specify a persona for creating the new segment (for a marketing campaign). In this example, the user inputs “pet owners.” In response, the chatbot provides a suggested persona name of “PET LOVER.” Correspondingly at the back-end, the process log pane 1320 may record that: persona did not exist, creating a new persona (PET LOVER), and persona (PET LOVER) created. One example of the new persona is shown in table 1330. In some embodiments, the new persona may be created following the operations 1130, 1140 in FIG. 11. In some embodiments, the persona PET LOVER already exists in a persona database or persona table, such that the system can directly retrieve data of corresponding persona customers from the persona database.

After creating the PET LOVER persona, the chatbot may ask whether the user wants to use any customer attributes as filters to select the target customers from the PET LOVER persona. The user can select one or more customer attributes from a reference link provided by the system, before the system generates the customer segment based on the filters. In some examples, the user can select any customer attributes related to: demographics, profile, site actions, online transactions, in-store transactions, etc. For example, the user can make two selections or conditions regarding the customers: website only customers, and customers situated at a specific location, e.g. Dallas. The system can then generate two filters corresponding to the two conditions respectively, and use the two filters to select target customers for the user's marketing campaign. Correspondingly at the back-end, the process log pane 1320 may record a summarized response that: the user wants to select Pet Lover persona customers who are website only customers situated at Dallas.

In some embodiments, many filters are pre-computed in association with the customer attributes. Once the user selects a customer attribute (e.g. gender, description, number of children, retailer membership, etc.), a corresponding pre-computed filter will be shown for the user to select a value or range of the filter, to be applied on the target customers. When a filter has different values or ranges, the system can display the value or range options to the user, e.g. when the user clicks on the filter. In some embodiments, the user is provided with an option to create a new filter on its own, e.g. a likelihood whether a customer is going to churn from a product or the retailer membership. Then, the user can apply a threshold on the filter to select target customers who have low probability to churn.

In some embodiments, the system automatically creates some new filters for the user to choose, after creating a persona based on the user's idea of the marketing campaign. The new filters may be generated automatically using an LLM based on the created persona, without any user intervention.

The system can then generate the customer segment accordingly for the user's marketing campaign, and provide the customer segment to the user in form of data tables, via the chatbot. After generating the customer segment, the chatbot can ask whether the user has any question related to the customer segment, and whether the user wants to modify or re-create the customer segment. In this example, the user asks for a distribution of the target customers in the generated segment based on gender and state. In response, the chatbot provides a table showing the distribution of the target customers, with a percentage of target customers listed for each pair of gender and state. Correspondingly at the back-end, the process log pane 1320 may record that: the segment is generated, and an answer to the user's question regarding the segment is generated.

In some embodiments, the user may modify the generated segment, e.g. by selecting “2” when facing the two options in the interaction pane 1310 or directly inputting: “modify the segment by considering customers who are between 25 and 45 years old.” The system will then add a filter to the customer segment to select only target customers between 25 and 45 years old. In some embodiments, the system can refresh a segment for a marketing campaign based on latest data, per user request, e.g. after the user clicks on a request ID associated with the segment. In some embodiments, the customer segment provided to the user includes a list of customer ID's or email ID's (voluntarily provided by the customers), for a campaign manager to target those customers when running the marketing campaign.

In some embodiments, the disclosed system embeds persona creation technology into a generative AI-driven interactive chatbot to understand and create customer segments for marketing campaigns. In some examples, based on a marketing campaign idea input by the user, e.g. “Upgrade Your Everyday,” the chatbot can interact with the user to determine a persona including target customers who have the modern minimalist style, with an income higher than certain threshold, belonging to a loyal customer group, and having moderate to high price preference of products.

On one hand, the user may start to input some idea about the marketing campaign without knowing any specific persona. The system will work with the user interactively to generate or identify a corresponding persona, and determine target customers from the persona for the marketing campaign. On the other hand, after the system creates a customer segment for a marketing campaign of a user, the system may generate some campaign ideas on top of the created segment. For example, the system can recommend a shopping season to run the campaign, some slogans to show the campaign, some manners (e.g. display ads, in-line ads) to show the campaign, etc., based on the created segment.

As such, a disclosed system enables an on-demand, LLM powered labelling of personas to customers, along with classification of products in item hierarchy to the specific persona being considered. The system can accurately capture a persona basket, which enables real time inferencing. For example, given a customer persona, the system captures the product hierarchy in product catalog with an accuracy of >99%. The system creates a geo-spatial concentration score at a most granular form that can be aggregated to create scores at any desired geographical region. The system generates and provides geo-spatial insight using persona in an interactive visual UI platform for actionability. The system can further use the generated data to solve different use cases.

In some embodiments, for a user case of assortment gap optimization, the system uses recursive LLM calls to overcome the context length issue and uses additive definition of mutually exclusive contexts to combine outputs back together. The system uses customer basket embedding as a query to search the customers' embedding space to provide real-time customer persona. With real-time and self-serve assessment of assortment gap without manual intervention, the system can fetch product recommendations based on assortment gap scores computed for stores. Each assortment gap score is a single dimensional score computed from assortment deviation of the store from its nearest stores and customer persona density around the store. These assortment gap scores can be used to easily rank the stores in order to recommend assortment gap optimization, for a configurable pixel size and configurable geo-boundary to markets.

In some embodiments, for a user case of marketplace recommendation to sellers, the system keeps all benefits as discussed above for assortment gap optimization. In addition, the system can provide market recommendation without prior data of (cold-start) products by understanding the product type and aligned customer type or persona. The system can provide an unsupervised market creation (geo-clustering) using an algorithm like DBSCAN.

In some embodiments, for a user case of recommending target customers to sellers or advertisers, the system generates real-time dynamic customer segments on the fly based on user queries input in natural language format, e.g. via an interactive chatbot. In some examples, the seller can modify customer segments using a natural language command, and query in form of natural language to understand different distribution of the customer segments. In various scenarios, the system can create target customers based on a campaign idea input by a user, and/or generate campaign ideas based on previously created customer segments.

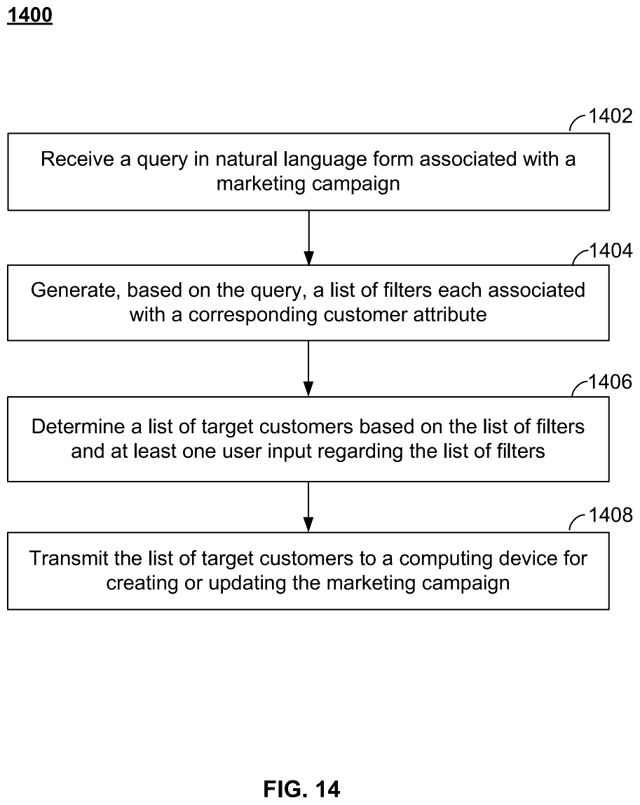

FIG. 14 shows a flowchart illustrating an example method 1400 for generating a customer segment for a marketing campaign, in accordance with some embodiments. In some embodiments, the method 1400 can be carried out by one or more computing devices, such as the persona based recommendation device 102 and/or the cloud-based engine 121 of FIG. 1. Beginning at operation 1402, a query associated with a marketing campaign is received in natural language form, e.g. as discussed above regarding the operation 410 in FIG. 4. At operation 1404, a list of filters each associated with a corresponding customer attribute is generated based on the query, e.g. as discussed above regarding the operation 470 in FIG. 4, the process 600 in FIG. 6 and the process 1100 in FIG. 11. At operation 1406, a list of target customers is determined based on the list of filters and at least one user input regarding the list of filters, e.g. as discussed above regarding the operation 470 in FIG. 4, the process 600 in FIG. 6 and the process 1100 in FIG. 11. The list of target customers is transmitted at operation 1408 to a computing device for creating or updating the marketing campaign.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
at least one processor; and
a non-transitory memory storing instructions, that when executed, cause the processor to:
receive a query in natural language form associated with a marketing campaign;
generate, based on the query, a list of filters each associated with a corresponding customer attribute;
generate a list of target customers based on the list of filters and at least one user input regarding the list of filters; and
transmit the list of target customers to a computing device for creating or updating the marketing campaign.

2. The system of claim 1, wherein the instructions, when executed, cause the processor to:
generate the corresponding customer attribute based on the query;
generate a prompt based on the corresponding customer attribute; and
input the prompt to at least one large language model and, in response, generate the list of filters.

3. The system of claim 1, wherein the instructions, when executed, cause the processor to:
receive, from a database, persona related data characterizing persona data for a plurality of customers; and
filter the persona related data using the list of filters and, in response, generate the list of target customers.

4. The system of claim 1, wherein the instructions, when executed, cause the processor to:
determine a persona basket including a list of relevant products based on the query;
determine a list of initial customers having a customer persona associated with the persona basket;
compute, for each of a plurality of location areas, a persona concentration score indicating a concentration of customers of the list of initial customers having the customer persona in the location area; and
generate the list of target customers based on the persona concentration scores.

5. The system of claim 4, wherein the instructions, when executed, cause the processor to:
generate a prompt based on a type of customer persona received in the recommendation request; and
input the prompt to at least one large language model and, in response, generate the persona basket including the list of relevant products.

6. The system of claim 4, wherein the instructions, when executed, cause the processor to:
receive customer attributes for a plurality of customers; and
generate the list of initial customers having the customer persona associated with the persona basket based on the customer attributes.

7. The system of claim 6, wherein the instructions, when executed, cause the processor to generate the list of target customers based on comparing embeddings generated from the customer attributes and embeddings of the persona basket.

8. The system of claim 7, wherein the instructions, when executed, cause the processor to:
compute a cosine distance metric between each of the embeddings generated from the customer attributes and each of the embeddings of the persona basket;
compare each of the cosine distance metrics to a threshold value; and
generate the list of target customers based on the comparisons.

9. The system of claim 4, wherein the instructions, when executed, cause the processor to:
compare, for each of the plurality of location areas, the persona concentration score to a threshold value;
determine, based on the comparisons, that at least one of the persona concentration scores is less than the threshold value; and
in response to the determination that the at least one of the persona concentration scores is less than the threshold value:
generate a prompt characterizing a request to generate similar products to the list of relevant products; and
input the prompt to at least one large language model and, in response, generate additional relevant products, and add the additional relevant products to the persona basket.

10. The system of claim 1, wherein the instructions, when executed, cause the processor to:
receive the at least one user input regarding the list of filters;
based on the at least one user input, adjust the list of filters; and
generate the list of target customers based on the adjusted list of filters.

11. A computer-implemented method, comprising:
receiving a query in natural language form associated with a marketing campaign;
generating, based on the query, a list of filters each associated with a corresponding customer attribute;
determining a list of target customers based on the list of filters and at least one user input regarding the list of filters; and
transmitting the list of target customers to a computing device for creating or updating the marketing campaign.

12. The computer-implemented method of claim 11, comprising:
generating the corresponding customer attribute based on the query;
generating a prompt based on the corresponding customer attribute; and
inputting the prompt to at least one large language model and, in response, generate the list of filters.

13. The computer-implemented method of claim 11, comprising:
receiving, from a database, persona related data characterizing persona data for a plurality of customers; and
filtering the persona related data using the list of filters and, in response, generate the list of target customers.

14. The computer-implemented method of claim 11, comprising:
determining a persona basket including a list of relevant products based on the query;
determining a list of initial customers having a customer persona associated with the persona basket;
computing, for each of a plurality of location areas, a persona concentration score indicating a concentration of customers of the list of initial customers having the customer persona in the location area; and
generating the list of target customers based on the persona concentration scores.

15. The computer-implemented method of claim 14, comprising:
generating a prompt based on a type of customer persona received in the recommendation request; and
inputting the prompt to at least one large language model and, in response, generate the persona basket including the list of relevant products.

16. The computer-implemented method of claim 14, comprising:
receiving customer attributes for a plurality of customers; and
generating the list of initial customers having the customer persona associated with the persona basket based on the customer attributes.

17. A non-transitory computer readable medium having instructions stored thereon, wherein the instructions, when executed by at least one processor, cause the at least one processor to:
receive a query in natural language form associated with a marketing campaign;
generate, based on the query, a list of filters each associated with a corresponding customer attribute;
generate a list of target customers based on the list of filters and at least one user input regarding the list of filters; and
transmit the list of target customers to a computing device for creating or updating the marketing campaign.

18. The non-transitory computer readable medium of claim 17, wherein the instructions, when executed, cause the at least one processor to:
generate the corresponding customer attribute based on the query;
generate a prompt based on the corresponding customer attribute; and
input the prompt to at least one large language model and, in response, generate the list of filters.

19. The non-transitory computer readable medium of claim 17, wherein the instructions, when executed, cause the at least one processor to:
receive, from a database, persona related data characterizing persona data for a plurality of customers; and
filter the persona related data using the list of filters and, in response, generate the list of target customers.

20. The non-transitory computer readable medium of claim 17, wherein the instructions, when executed, cause the at least one processor to:
determine a persona basket including a list of relevant products based on the query;
determine a list of initial customers having a customer persona associated with the persona basket;
compute, for each of a plurality of location areas, a persona concentration score indicating a concentration of customers of the list of initial customers having the customer persona in the location area; and
generate the list of target customers based on the persona concentration scores.
